(19) United States
(12) Patent Application Publication
(10) Pub. No.: US 2024/0100637 A1
(43) Pub. Date: Mar. 28, 2024

(54) ADJUSTABLE FASTENER FEEDER FLEXIBLE AND VACUUM FASTENER GRIPPING ATTACHMENT FOR AUTOMATIC SCREWDRIVER

(71) Applicant: ROBOTIQ INC., St-Nicolas (CA)

(72) Inventors: Renaud SANSFAÇON, Québec (CA); Isabelle FORTIER, Québec (CA)

(21) Appl. No.: 18/526,744

(22) Filed: Dec. 1, 2023

Related U.S. Application Data
(63) Continuation of application No. PCT/CA2022/051008, filed on Jun. 23, 2022.
(60) Provisional application No. 63/215,170, filed on Jun. 25, 2021.
(60) Provisional application No. 63/215,208, filed on Jun. 25, 2021.

(51) Int. Cl. B23P 19/00

(52) U.S. Cl. CPC B23P 19/006

(57) ABSTRACT

The present disclosure relates to flexible vacuum fastener gripping attachment for a screwdriver and an adjustable screw feeder operable to provide screws to an automatic screwdriving unit. The flexible vacuum fastener gripping attachment may be made of flexible material and may be operable to surround a bit of an automated screwdriving unit while a vacuum is communicated to the gripping attachment. The fastener feeder may be easily adjusted to different types and/or sizes since it may be adjusted by rotating a thumb screw accessible from the outside of the casing of the fastener feeder while the fastener feeder is operating.

### CROSS-REFERENCE TO RELATED APPLICATIONS

This application is a continuation of PCT application serial number PCT/CA2022/051008, filed Jun. 23, 2022, designating the US, now pending that claims priority from U.S. Provisional Patent Application 63/215,170 filed Jun. 25, 2021 and U.S. Provisional Patent Application 63/215,208 filed Jun. 25, 2021, the contents of which are hereby incorporated by reference.

### TECHNICAL FIELD

The present patent application relates to the field of automatic screwdrivers and their fastener feeders. More particularly to automatic screwdrivers with vacuum screw gripping attachments and to an automated screw feeder adjustable to different sizes or types of fasteners.

### BACKGROUND

A screw feeder is a unit operable to isolate a single screw at its output and present it in a predetermined position. This type of device has been used for a number of years and has been of significant importance in the automation of manufacturing parts and assemblies. As a matter of fact, a fastener feeder can be used by an automatic screwdriver (robot) in an automated process, the robot registering the location to which it may revert to when it requires to pick-up a new fastener to perform its operations. Fastener feeders are generally used by fully automated robotic arms but they may also be used by human operators. Fastener feeders may be used to facilitate the overall screwdriving operations by providing fasteners at a given location with a constant orientation.

Most fastener feeder units known in the prior art are operable to work with a certain type and size of fastener and cannot be modified by the operator to accept a different type and/or size of fastener. In larger manufacturing operations, this may be an acceptable limitation as a particular combination of automated screwdriving robot and fastener feeder may see its use restricted to one type and size of fastener for long periods. However, the fact that known fastener feeders may not be adjusted at any desired time may not be optimal for smaller manufacturing operations in which, for example, a single automated screwdriving unit may be used to assemble a product using a number of different fasteners.

On the other hand, automatic screwdriving units have existed for several years and have been instrumental in the automation of manufacturing parts and assemblies. The automatic screwdrivers may be attached to a fully automated robotic arm or may be used by a human. When used by a human operator, the automatic screwdriver may facilitate the screwdriving operations by providing tightening the fastener in the desired location until reaching a certain threshold value (e.g. maximum allowable torque) and thereafter automatically stopping the screwdriving process. Automatic screwdrivers, as known in the prior art, may further be operable to automatically pick up a fastener, e.g. from a screw feeding device, and to connect to a vacuum source to improve the screw pick-up feature.

Most automatic screwdriving units connectable to a vacuum source, such as to aid in the fastener pick-up feature, have the vacuum source and connection as separate units from the automatic screwdriver. As a matter of fact, numerous adapters are available to connect to a screwdriver's casing, spindle or bit to provide a vacuum channel for picking up fasteners to be driven by the screwdriver's bit.

It is also known in the art of automatic screwdriver to provide a fastener gripping part, such that the fastener remains within an effective range of the screwdriver's bit throughout the whole fastening operation (i.e. the fastener remains in a position aligned with the screwdriver between the time it is picked up and the moment the fastener is driven inside the desired hole). However, fastener gripping parts for automatic screwdrivers are generally made of metal and manufactured to narrow specifications such that they are only usable with a limited number of fastener sizes and/or types. These gripping parts are generally designed to magnetically, mechanically or pneumatically hold the fastener in place. Flexible fastener grippers are typically found for non-powered screwdrivers. These flexible parts generally fix themselves on the screwdriver's bit and allow the mechanical holding of a number of fasteners sizes and/or types.

### SUMMARY

Applicant has found that providing a vacuum source and communication channels as part of the automatic screwdriving unit has significant benefits over the systems described in the prior art. As a matter of fact, when integrated inside the screwdriving unit, such as inside the same casing as the motor driving the screwdriver, the dimensions and the encumbrance of the screwdriving unit may be reduced. Furthermore, an integrated vacuum source and communication channels reduce the number of parts, thus reduces the complexity of use, and removes the risk of detrimentally affecting the screwdriving unit if the parts are incorrectly mounted together.

Therefore, the integration of the vacuum source and the communication channels inside the screwdriving unit may significantly improve the operation of the screwdriver. This may be particularly relevant for users in a less automated production environment (e.g. typically smaller operations) as it reduces the potential risk of mounting error which may lead to damage of the screwdriver or the product's parts being fastened.

Additionally, the use of integrated communication channels, particularly surrounding the screwdriver's motor, allows for efficient cooling of the motor.

Applicant has further found that using a flexible vacuum gripping attachment, such as a flexible sleeve surrounding the screwdriver's bit, allows for the gripping attachment to be usable on a significant number of fastener sizes and types. Using flexible material, such as NBR (nitrile butadiene rubber), further allows the vacuum to help to position and to align the fastener inside the sleeve, such that the screwdriver's bit may engage with the fastener and the product's parts to be fastened without significant misalignment.

A first broad aspect is a flexible vacuum fastener gripping attachment for a screwdriver including: a clip section operable to secure a first end of the flexible vacuum fastener gripping attachment to a non-rotatable part of the screwdriver; a deformable section such that an upward force exerted on the flexible vacuum fastener gripping attachment deforms the deformable section first; a second end having a fastener head guiding zone; a channel connecting the first end to the second end, wherein the flexible vacuum fastener gripping attachment is made of flexible material and is operable to surround a bit of the screwdriver while a vacuum is communicated in the channel.

In some embodiments, the clip section comprises a fast-attachment clip.

In some embodiments, the deformable section comprises a section with thinner sidewalls.

In some embodiments, the deformable section comprises one of a bellow and an accordion section.

In some embodiments, the fastener guiding zone is shaped to reciprocate a type of standard fastener head.

A second broad aspect is a screwdriving unit including: a housing including: a vacuum source; a motor; a spindle operable to receive a screwdriver bit; and a vacuum communication channel operably connected to the vacuum source and bordering the motor and the spindle; and a flexible vacuum fastener gripping attachment as defined herein, wherein the flexible vacuum fastener gripping attachment is attached to the housing and the vacuum communication channel is operably connected to the first end of the flexible vacuum fastener gripping attachment.

In some embodiments, the casing further comprises a compressed gas intake and a gas exhaust, and the vacuum source is a venturi vacuum device operably connected to the compressed gas intake and the gas exhaust.

A third broad aspect is a method of performing a screwdriving operation including: providing a vacuum to a vacuum fastener gripping attachment; initiating a slow rotation of a screwdriver's bit; applying the vacuum to a fastener's head, such that the fastener's head is inserted in the vacuum fastener gripping attachment; positioning the screwdriving unit over a desired screwdriving location; performing the screwdriving operation; removing the screwdriver's bit from the fastener's head; and stopping the vacuum.

Applicant has also discovered that providing an adjustment mechanism operable to modify the fasteners accepted and output by an automated fastener feeder provides significant advantages over prior art screw feeders that require maintenance (e.g. changing parts) to modify the type and/or size of fasteners being output by the device. The adjustment mechanism may be operated by the user and may therefore not require any specific knowledge of the machine or any special skills that may be required in maintaining a mechanical machine.

Additionally, the adjustment mechanism, as described herein, provides means for a smaller manufacturing operations to save significant costs as it allows the same machines to perform a task (e.g. screwdriving) without requiring long downtimes otherwise required to adapt the machines to different types or sizes of fasteners. Another significant advantage over the prior art is that the adjustment mechanism of the fastener feeder does not require any additional parts, such as necessary in prior art feeders in which a user may change the vibrating rails.

In order to provide simple and quick adjustments to the fastener feeder, the Applicant has found that it may be particularly desirable to have one adjustment thumb screw operable to adjust the relative distance between both vibrating rails and a second adjustment thumb screw operable to adjust the width of the fastener guiding members at the isolator.

Fastener feeders, as known in the prior art, generally have a sensor at the isolator. The sensor may be operable to detect the presence of a fastener in the isolator and, when no fastener is present, to command the system to pick a new fastener. The isolator sensor is typically positioned with a line-of-sight below the head of the fastener at the output position of the isolator. This position may be particularly useful, and generally necessary when the fastener feeder is operated with fasteners of small sizes (e.g. the fastener's head may be sufficiently small to not always be detected by the sensor). However, this positioning of the sensor may lead to a number of issues, such as when a screwdriver, or an operator, picks up the fastener from the isolator but remains in a position in which the sensor may not detect the fastener. This may result in a command for the fastener feeder to operate the isolator to pick a new fastener up; thereafter potentially causing detrimental interference with the screwdriver or operator that remained in the isolator's pathing.

Applicant has found that using an additional sensor, which may be positioned upwards with a line-of-sight descending over the fastener to be picked up, as well as the typically aligned sensor, may be beneficial to reduce the risks of interference to a minimum.

A first broad aspect is an adjustable fastener feeding device including: a housing including: a receptacle including at least one blade; a motor operable to rotate the at least one blade; and a rail assembly including two rails separated by a first gap, the rail assembly being positioned at a height inside the receptacle and being operable to receive a fastener guided by the rotation of the at least one blade; and an output isolator including two fastener guiding member separated by a second gap, wherein the first gap is adjustable by a first adjustment mechanism and the second gap is adjustable by a second adjustment mechanism, the first and second adjustment mechanisms being accessible from outside the housing.

In some embodiments, the receptacle comprises a rotary section and a stationary section, the at least one blade being fixed to the rotary section and the motor being operable to rotate the rotary section.

In some embodiments, the adjustable fastener feeding device further includes a brush positioned at a height over the rail assembly, wherein the brush is adjustable in height by a brush adjustment mechanism.

In some embodiments, the adjustable fastener feeding device further includes an output fastener head restrictor positioned at a height between the rail assembly and the output isolator, wherein the output fastener head restrictor is adjustable in height by a head restrictor adjustment mechanism being accessible from outside the housing.

In some embodiments, the first adjustment mechanism further comprises a rack-and-pinion rail mounting and a rail adjustment screw, wherein a rotation of the rail adjustment screw is operable to displace the two rails, each in an opposed direction, such as to adjust the first gap.

In some embodiments, the second adjustment mechanism further comprises a rack-and-pinion isolator mounting and an isolator adjustment screw, wherein a rotation of the isolator adjustment screw is operable to displace the two fastener guiding members, each in an opposed direction, such as to adjust the second gap.

In some embodiments, the head restrictor adjustment mechanism further comprises a biasing member and a head restrictor adjustment screw, wherein a rotation of the head restrictor adjustment screw is operable to change a height of the output fastener head restrictor.

In some embodiments, at least one of the rail adjustment screw, the isolator adjustment screw and the head restrictor adjustment screw is a thumb screw.

In some embodiments, the output isolator further comprises an isolator motor operable to displace the output isolator from an input position to an output position, the input position being aligned with the rail assembly.

In some embodiments, the adjustable fastener feeding device further includes a vibration source operable to vibrate the rail assembly.

In some embodiments, the rail assembly is angled towards the output isolator.

In some embodiments, the adjustable fastener feeding device further includes at least one sensor operable to detect a presence of a fastener in the output isolator.

In some embodiments, a first sensor is horizontally aligned with a bottom of the fastener's head and a second sensor is positioned at a downwards angle to detect at least one of a top of the fastener's head and an object in vicinity over the fastener's head.

A second broad aspect is a method of adjusting a fastener feeding device including: adjusting a first gap width between opposed rails of a rail assembly using a first adjustment mechanism; and adjusting a second gap width between opposed fastener guiding members of an output isolator using a second adjustment mechanism, wherein the first and second adjustment mechanisms are accessible from outside a housing of the fastener feeding device.

In some embodiments, the method further includes stopping the fastener feeding device and restarting the fastener feeding device.

In some embodiments, the method further includes adjusting a height of a brush over the rail assembly.

In some embodiments, the method further includes adjusting a height of an output fastener head restrictor using a head restrictor adjustment mechanism, wherein the head restrictor adjustment mechanism is accessible from outside the housing of the fastener feeding device.

In some embodiments, the adjusting the first gap is done by a rotation of a single rail adjustment screw.

In some embodiments, the adjusting the second gap is done by a rotation of a single isolator adjustment screw.

In some embodiments, the adjusting the height of an output fastener head restrictor is done by a rotation of a single head restrictor adjustment screw.

### BRIEF DESCRIPTION OF THE DRAWINGS

The invention will be better understood by way of the following detailed description of embodiments of the invention with reference to the appended drawings, in which:

FIG. 1A is an isometric view of an exemplary prior art screw feeder;

FIG. 1B is an isometric view of a different exemplary prior art screw feeder in which the vibrating rails may be replaced to adjust the screw feeder for different types or sizes of screws;

FIG. 2A is an isometric view illustrating the front side of an exemplary adjustable automatic fastener feeder;

FIG. 2B is an isometric view illustrating the back side of an exemplary adjustable automatic fastener feeder;

FIG. 3 is an internal view of the front parts of an exemplary adjustable automatic fastener feeder;

FIG. 4 is an internal view of the aft parts of an exemplary adjustable automatic fastener feeder;

FIGS. 5 and 6 are detailed views of the vibrating rails adjustment mechanism of an exemplary adjustable automatic fastener feeder;

FIG. 7 is a detailed view of the adjustment mechanism and movement mechanism of the isolator of an exemplary adjustable automatic fastener feeder;

FIG. 8 is an isometric view of the internal components of the sensor system for the isolator of an exemplary adjustable automatic fastener feeder;

FIG. 9 is a side view of the internal components of the sensor system for the isolator of an exemplary adjustable automatic fastener feeder;

FIG. 10 is an exemplary method of adjusting an adjustable automatic fastener feeder in which the fastener feeder is stopped while performing the adjustments; and

FIG. 11 is an exemplary method of adjusting an adjustable automatic fastener feeder in which the main adjustments are done while the fastener feeder is functioning.

FIG. 12A is a schematic drawing of an exemplary prior art vacuum gripping attachment that is separate from the screwdriving unit;

FIG. 12B is a schematic drawing of an exemplary vacuum gripping connector mountable to a screwdriving unit;

FIG. 12C is a schematic drawing of a flexible screw gripping sleeve attachable to a screwdriver's bit;

FIG. 13 is a side view of an exemplary screwdriving unit including an integrated vacuum source and communication channels and a flexible vacuum gripping attachment;

FIG. 14 is a sectional view of an exemplary screwdriving unit including an integrated vacuum source and communication channels and a flexible vacuum gripping attachment;

FIG. 15 is a sectional view of the spindle and flexible vacuum gripping attachment of an exemplary screwdriving unit;

FIG. 16A is a schematic drawing of the sectional view of an exemplary flexible vacuum gripping attachment;

FIG. 16B is a schematic drawing of the partial sectional view of the upwards deflection induced by a vertical compression force.

FIG. 16C is a schematic drawing of the partial sectional view of a tapered fastener receiving section of an exemplary flexible vacuum gripping attachment;

FIG. 16D is a schematic drawing of the partial sectional view of a washer-type fastener head guiding zone of an exemplary flexible vacuum gripping attachment; and

FIG. 17 is an exemplary method of screwdriving operations using a vacuum gripping attachment.

### DETAILED DESCRIPTION

The present disclosure relates to a screwdriving unit with a fastener gripping attachment and an adjustable fastener feeding device, such as an adjustable screw feeder.

Screw feeders may be particularly useful in automated manufacturing processes as they may be operable to reliably provide fasteners (i.e. always at the same location with the desired orientation) to an automated tool such as a screwdriver mounted on a robotic arm. As is known in the art, a screw feeder may be operable to separate and isolate a desired type and size of fastener from a fastener load, and to output an isolated fastener at a specific location. At the isolator (i.e. the output), the fastener may always be in its desired orientation, such that the head of the fastener is typically upwards and allowing a tool to mate with its end (e.g. a screwdriver's bit may operatively couple with the head of an isolated screw).

While sometimes referred to as a screw feeder throughout this disclosure, a person skilled in the art will appreciate that any type of fasteners may be used in the feeder. For example, the feeder may be operable to isolate screws, bolts, rivets, etc.

On the other hand, although this description emphasizes on providing an integrated vacuum source and communication channels, the reader must understand that the flexible vacuum gripping attachment may be used with an external vacuum source and/or be connected to a vacuum adapter for screwdrivers as known in the art. Additionally, while the description mainly details the use of the system as part of an automatic screwdriving unit, for example a unit that may be fixed to a robotic arm, the reader must understand that the integrated vacuum source and communication channels and/or the flexible fastener gripping attachment may be equivalently used in a configuration in which the screwdriving unit is not designed for automated robotic use (e.g. the screwdriving unit may be a unit used by a human operator for a screwdriving operation).

Automated screwdrivers are well known in the art and are widely used in the manufacturing processes for numerous products. These automated screwdrivers may be mounted on robotic arms or may alternatively be used by human operators, depending on the level of automation of the assembly line in which it is used. Therefore, the automation of the screwdrivers may range from the automatic control of the screwdriving (e.g. fastening a screw until a torque threshold is reached) to automatic control of the position of the screwdriving unit between a fastener feeding device to a part to be fastened.

Such screwdriving units may further include a fastener gripping attachment, such as to secure a fastener to the screwdriver until it has been successfully fastened to a part.

Prior Art for the Fastener Feeding Device

Screw feeders known in the prior art are operable to work with a certain type and size of fasteners and generally cannot be modified by the operator, at least in a timely manner, to accept a different type and/or size of fastener. As a matter of fact, while some prior art screw feeders may be modified to accommodate different sizes, they typically require it to be done through maintenance of the device. This may require the stripping down of the device, such that the user may completely remove the vibrating rails and/or the isolator and replace the parts with new parts designed for the different type or size of fastener. Alternatively, some screw feeders require the device to be sent to its manufacturer such that the changes to the device may be done by trained professionals and the device may be correctly calibrated to the new desired fasteners.

In larger manufacturing operations, the use of such screw feeders may be acceptable as a particular combination of automated screwdriving robot, which can be a screwdriver described herein, and fastener feeder may see its use restricted to one type and size of fastener for long periods. In such operations, the feeder may never require to be adjusted to different fasteners or, if required, it may be during a production downtime not caused by the need to adjust the feeder.

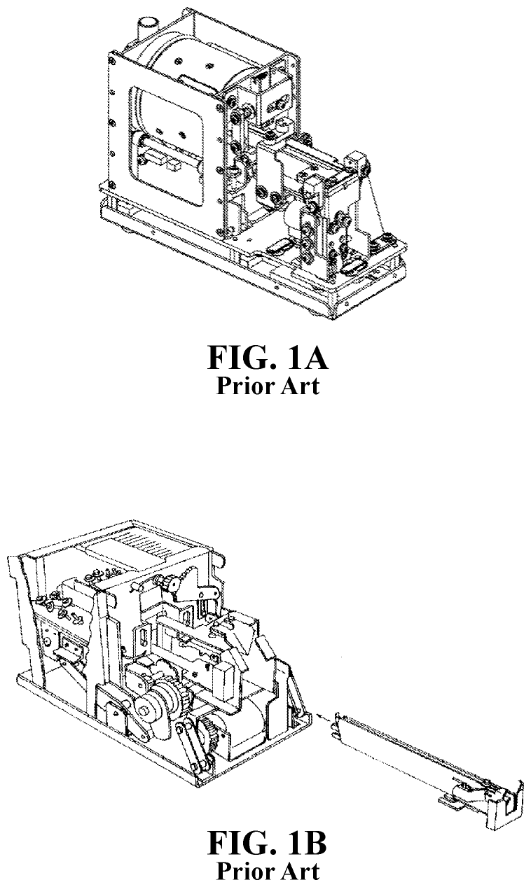

FIG. 1A illustrates one such exemplary prior art screw feeder. In this device, the parts (e.g. the transfer rails) may not be adjusted to accept different types or sizes of fasteners. While these may be changed during heavy maintenance (e.g. removing a significant number of parts), the manufacturer generally suggests sending the unit such that they properly adjust and calibrate it.

Similarly, FIG. 1B illustrates a different exemplary prior art screw feeder in which the vibrating rails may be replaced to adjust the screw feeder for different types or sizes of screws. In this prior art solution, the rails remain accessible during maintenance and the part may be entirely changed to a new part (e.g. new part in which the width of the gap between the rails is of the new desired length).

However, the fact that known fastener feeders may not be adjusted at any desired time, by the operator of the feeder, may not be optimal for smaller manufacturing operations in which, for example, a single automated screwdriving unit may be used to assemble a product using a number of different fasteners. Additionally, the fact that some prior art solutions require different parts may not be optimal as it may require storing several parts in inventory and require some maintenance to change between parts.

Adjustable Fastener Feeder

The present disclosure provides for a fastener feeder equipped with an integrated adjustment mechanism operable to modify the fasteners accepted and output by an automated fastener feeder. In order to provide simple and quick adjustments to the fastener feeder, the fastener feeder may have one adjustment thumb screw operable to control the adjustment of the relative distance between both vibrating rails and a second adjustment thumb screw operable to control the adjustment of the width of the fastener guiding members at the isolator. Additionally, the output of the fastener feeder may be equipped with an adjustable fastener head restrictor for which a thumb screw may provide the control of the height adjustment.

In some embodiments, the vibrating rails adjustment mechanism, the isolator adjustment mechanism and the output fastener head restrictor may be accessible from the outside of the feeder's housing. This may provide a number of significant benefits with regard to prior art solutions. As a matter of fact, as these adjustment mechanisms are located outside of the feeder's housing, the feeder may not be required to be stopped in order to adjust the various parameters. This may therefore decrease production downtime and thus provide a more efficient manufacturing solution. Additionally, the adjustment mechanisms may not require any tool to be operated.

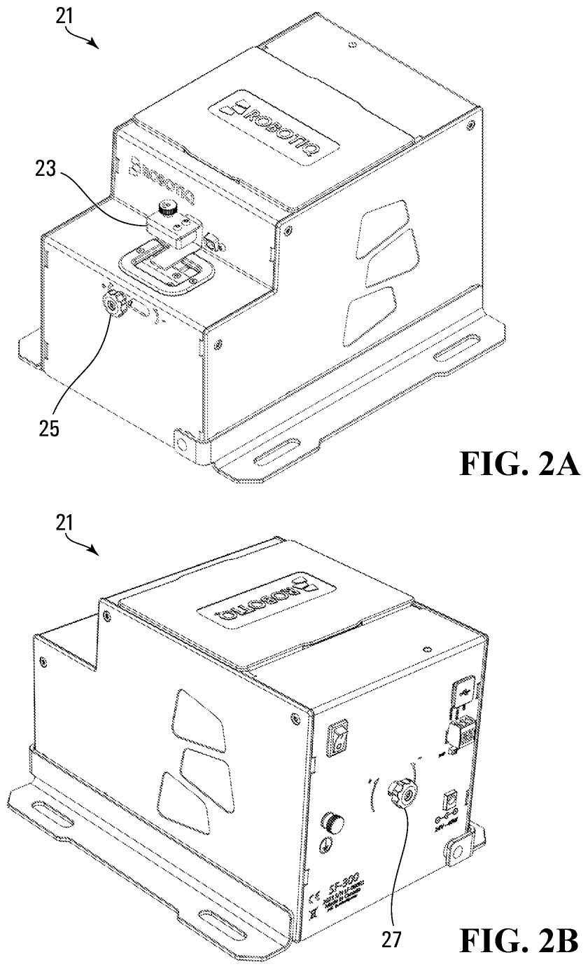

Now referring to FIG. 2A which is an isometric view illustrating the front side of an exemplary adjustable automatic fastener feeder 21. The feeder 21 may be enclosed in a housing protecting most moving components from the environment, such that it may reduce the risk of interference and safety hazards. The feeder 21 may have a clear window on top, such that an operator may easily assess the number of fasteners remaining in the device. The clear window may further be operable to be opened such that the operator may fill the feeder 21 with fasteners.

The feeder 21 may further include an isolator 23 operable to accept a fastener from the device's rails and to displace it to an output position. The isolator 23 may thus ensure that it always isolate a single fastener and that this fastener retains its orientation (e.g. the fastener's head being upwards). As such, the isolator 23 provides a repeatable output that may be used by an automated tool picking up the fastener being isolated.

The frontal face of the feeder 21 may further include the first adjustment mechanism, which may be the isolator adjustment mechanism. As illustrated, the isolator adjustment mechanism may include an isolator thumb screw 25 used as the control for the isolator adjustment mechanism. As will be further detailed herein, the isolator thumb screw 25 may be operable to adjust the width between both sides of the fastener guiding members in the isolator. For example, the isolator thumb screw 25, when turned clockwise, may increase the width of the gap and, when turned counter-clockwise, may decrease the width of the gap. This may be implemented using a simple mechanical design of rack-and-pinions, a first one providing a linear displacement to a first side of the fastener guiding members and a second one, using an intermediary gear, providing an opposed displacement to the second side of the fastener guiding members. A person skilled in the art will appreciate that other designs for the adjustability of the gap between the sides of the isolator's fastener guiding members may be used without departing from the teachings of this disclosure.

Similarly, FIG. 2B illustrates the back side of the adjustable automatic fastener feeder 21 embodiment of FIG. 2A. In this embodiment, the second adjustment mechanism, for adjusting the width between the vibrating rails, may be controlled by a rail thumb screw 27 accessible on the back side of the device. As described herein for the first adjustment mechanism, the rotation of the rail thumb screw 27 may increase or decrease the gap between each rail, such that it may be adjusted to the desired width accommodating the desired type/size of fastener to be output.

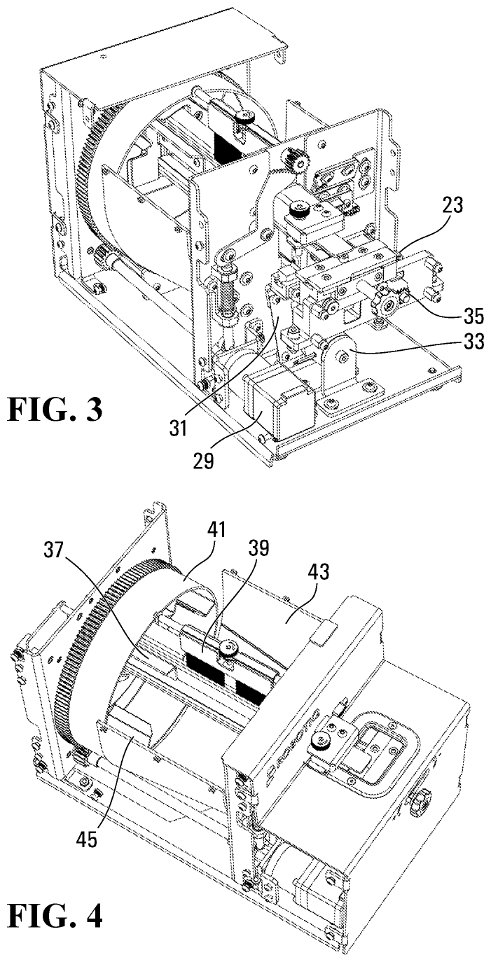

FIGS. 3 and 4 illustrate the internal components of the fastener feeder. As is known in the art, fasteners may be initially entered in the feeder's receptacle in a disorganized manner by a user. The receptacle may be a tumbler equipped with blades at one end. The blades push the fasteners around, such that some fall on a vibrating rail. The vibrating rail has a central gap to allow for the fasteners to fall in place, i.e. head resting on both sides of the central gap and the remaining section (e.g. threaded section for screws) oriented towards the bottom. Over the vibrating rail, there may be a brush to push off fasteners that would be misplaced. The vibrating rail may further be slightly tilted towards the output and, in combination with the vibrations imparted to the rails, may provide a linear movement of the fasteners towards the output.

In the embodiment of FIGS. 3 and 4, a motor 29 may provide both the inputs to the brush 39 and to the tumbler drum 41. While the motor 29 may output a single rotating shaft to the drum 41, such as to rotate it, the brush 39 may be connected to the motor's 29 shaft through mechanical links changing its rotation to a linear displacement and further changing the linear displacement to an angular displacement of limited to either side of the rails 37 (e.g. the brush 39 may sweep up to around 45° on each side of the rails).

The vibrating rails 37 of the fastener feeder may be mounted on a biasing mechanism 31 (e.g. springs) to allow the rails 37 to vibrate without vibrating all of the device. The vibrations imparted to the rails 37 may be produced by an electromagnetic vibration generator 33 or by any other means as known in the art.

As detailed herein, fasteners may be inserted in the main receptacle 43 of the tumbler. The main receptacle may be angled towards a rear portion in which the tumbler drum 41 rotates. The tumbler drum 41 may be equipped with a number of blades 45 operable to displace fasteners from a bottom of the drum to a top of the drum, such as to drop them over the vibrating rails 37. The vibration of the rails 37 may help fasteners to achieve the desired orientation while allowing them to be displaced towards the output. Misaligned fasteners may be rejected from the rails and fall inside the receptacle 43, repeating the process until it is correctly oriented and output.

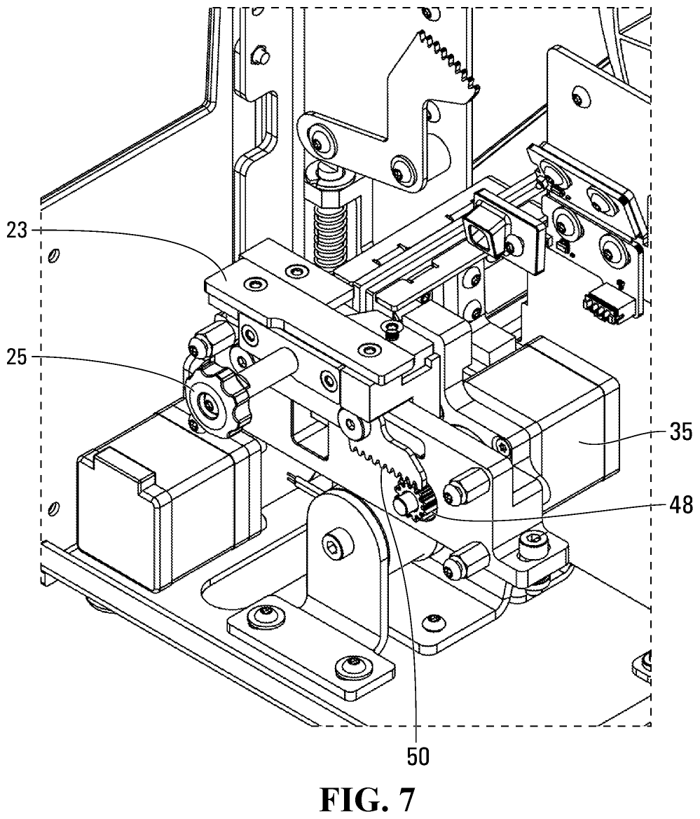

As will be further described herein, the output of the feeder may be done through an isolator 23 limiting the output to a single fastener correctly oriented and positioned at a specific location. FIG. 7 further illustrates the isolator's 23 parts and mechanism, including the isolator motor 35 providing the linear displacement of the isolator 23 between a first position in which the isolator 23 may accept a new fastener (i.e. in front of the vibrating rails 37) and a second position for allowing a tool to pick the fastener up.

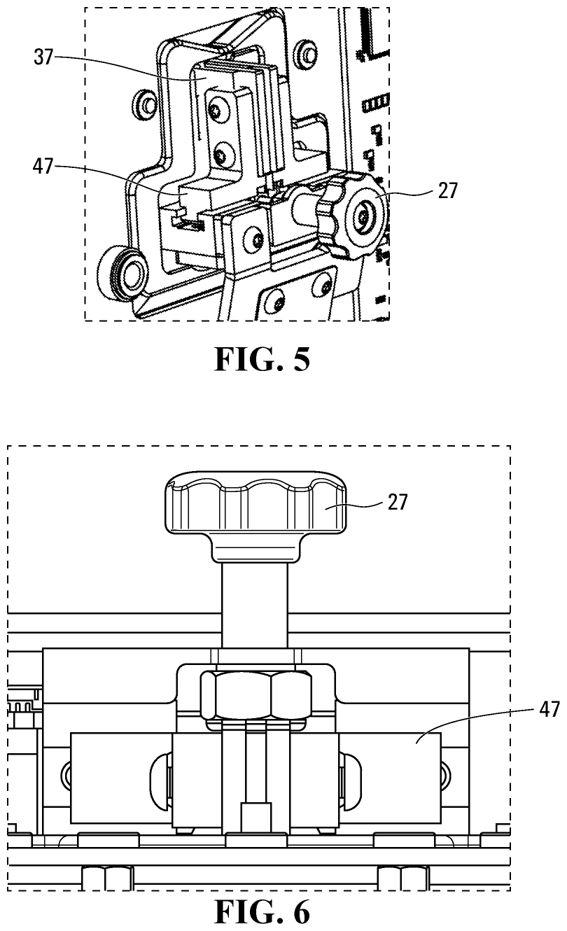

Now referring to FIGS. 5 and 6 which are detailed views of the vibrating rails adjustment mechanism. As described herein for the first adjustment mechanism, operable to adjust the width of the isolator's output, the vibrating rails 37 may be adjusted through a single rail thumb screw 27. At the adjusting end of the vibrating rails 37, each rail 37 may be mounted to an L-type bracket 47. The section of the bracket 47 perpendicular to the rails 37 may further include a T-type mounting to the adjusting mechanism, such that it increases the stability of the mechanism and of the rails 37. The brackets 47 may be operably connected to a rack-and-pinion type of adjusting mechanism, such that a rotation of the rail thumb screw 27 provides a linear displacement of each rail 37. As described herein, a first pinion on the rail thumb screw 27 shaft may be directly linked to a first rack providing a linear displacement to a first rail and a second pinion may be linked to a second rack, through an intermediary gear, providing an opposed displacement to the second rail.

Now referring to FIG. 7 which is a detailed view of the adjustment mechanism and movement mechanism of the isolator 23 of an exemplary adjustable automatic fastener feeder. In this embodiment, the fastener may be transferred from the vibrating rails to the isolator 23 when the isolator 23 is in its first position (e.g. an input position). The isolator 23 may hold the fastener's head between two fastener holding parts. The width of the gap between the opposing sides of the fastener holding parts may be adjusted such as to hold the fastener's head while still providing enough space to minimize the friction between the fastener's body and the parts when the fastener will be picked up by a tool and removed from the isolator 23. As such, the spacing between both fasteners holding parts may not necessarily be the same as the spacing between the vibrating rails. Therefore, the adjustment mechanisms, for both the vibrating rails and the isolator 23, may be independent.

As detailed herein, the adjustment of the gap's width between the opposed parts of the isolator's 23 fastener guiding members may be adjusted through the clockwise or counter-clockwise rotation of the isolator thumb screw 25 (i.e. the isolator adjustment mechanism). In this embodiment, the isolator 23 may have a displaceable tray mounted on top of a fixed based. The motor may be included in the fixed based and provide the necessary displacement mechanism for the isolator's 23 tray.

FIG. 7 further illustrates an embodiment of the displacement mechanism of the isolator 23. In this embodiment, the isolator motor 35 may have a rotating shaft positioned horizontally, with a pinion 48 at its distal end. The pinion 48 is operable to translate its rotational movement to a rack 50 on which the isolator's tray is mounted. As such, depending on the direction of the rotation from the motor 35 and the pinion 48, the isolator's 23 tray may be moved from the first position (i.e. aligned with the vibrating rails to accept a new fastener) to a second position (i.e. an output position offset with regards to the first position).

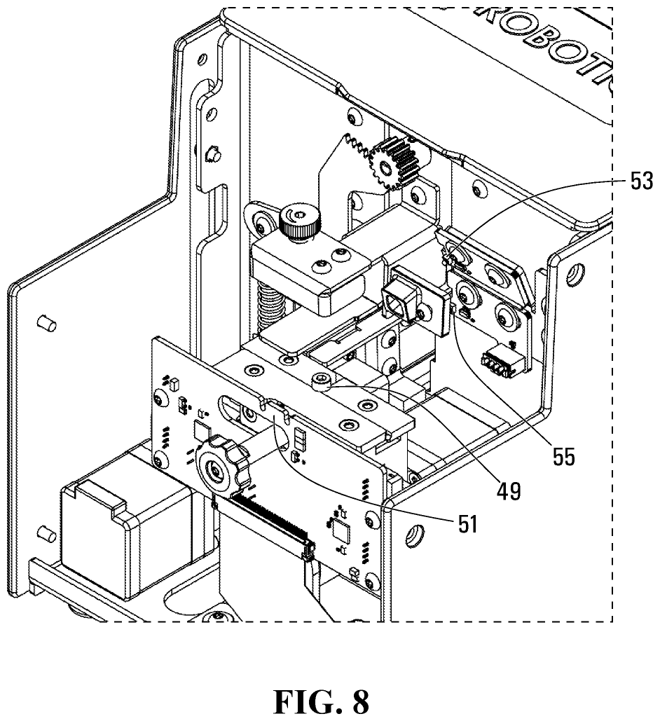

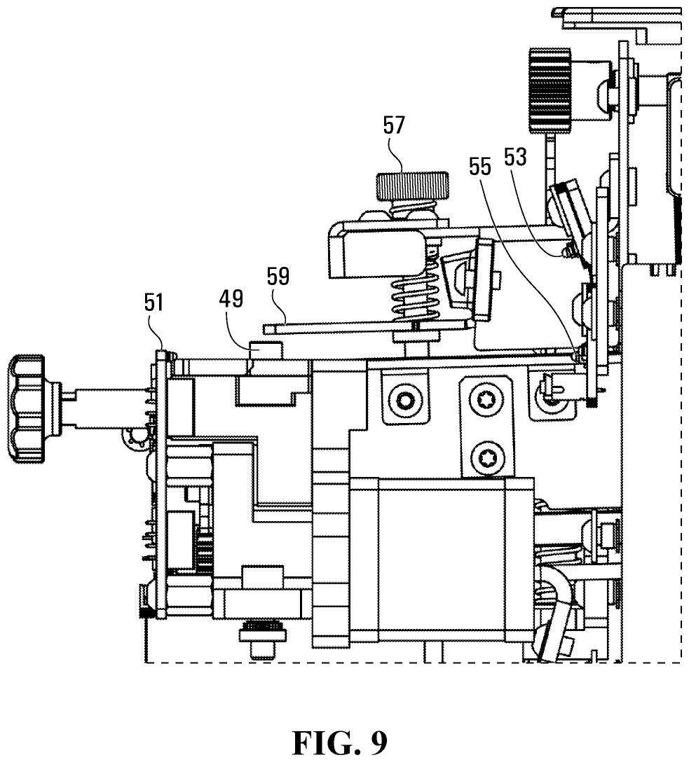

As will be further described in FIGS. 8 and 9, the isolator 23 may be moved from its first and second positions depending on the detection of the presence of a fastener by the sensors. For example, when a fastener is detected and the isolator is in its output position, the motor will not be operated. Following the removal of the fastener from the output, the sensor may detect the absence of a fastener and provide a command to the isolator motor 35 such that it is displaced and aligned with the vibrating rails. The controller may control the isolator to move back towards its output position when a new fastener is in place in the isolator. The control logic may be either time-based (e.g. the isolator may remain in a position aligned with the rails for a given amount of time) or may be sensor-based (e.g. remains in position until a new fastener is detected as being inside the isolator).

A person skilled in the art will appreciate that any other type of movement mechanism may be used to translate the position of the isolator from the first position to the second position, without departing from the teachings of this disclosure. It will also be appreciated that, instead of displacing the isolator to ensure a single fastener is provided at the output, a similar functionality may be provided by any type of gate or blocking mechanism between the vibrating rails and the isolator (e.g. a gate that may be controlled in an open or closed position and that may be operable to only a single fastener through at any given time).

In some embodiments, the fastener feeder may include a fastener head restrictor at its output, i.e. in the section between the end of the vibrating rails and the isolator. FIG. 9 illustrates this embodiment, the output fastener head restrictor 59 being at a desired height to allow the passage of a fastener while restricting any potential overlap of fastener heads. As a matter of fact, certain types of fasteners (e.g. fasteners with countersunk heads) may have a tendency to overlapping when pushed towards the isolator. This overlapping may be detrimental to the operation of the fastener feeder as certain fasteners may block the path to the isolator. Moreover, the overlapping may lead to issues with the operation of the isolator and/or with the picking up of the fastener by a screwdriver, as illustrated in FIG. 13 for example, if more than one fastener is present in the holding members of the isolator (e.g. in a situation where the sensors, as described further herein, would not detect the faulty configuration and command the operation of the isolator).

In such embodiments, the fastener head restrictor 59 may be a plate adjustable in height. As such, the fastener head restrictor 59 may be connected to a height adjustment mechanism including a head restrictor thumb screw 57. The height adjustment mechanism for the head restrictor 59 may be biased in position with a spring or any other type of biasing member. A rotation of the head restrictor thumb screw 57 may thus compress or expand the biasing member and provide height adjustment capabilities. A person skilled in the art will appreciate that any height adjustment mechanism may be equivalently used without departing from the teachings of this disclosure.

While mainly described herein as using a mechanical type of adjustment mechanisms for both the isolator and the vibrating rails, a person skilled in the art will appreciate that any other type of adjusting mechanism or control thereof may be used without departing from the teachings of this disclosure. For example, instead of controlling the adjustment mechanism through thumb screws, the adjustment mechanisms may be electronically controlled, and one or more servo motors may provide the required displacements to the parts.

In some embodiments, there may be a number of pre-set width adjustments (e.g. for all metric and/or imperial sizes of screws) selectable through an electronic control (e.g. a touch screen providing menus for selecting the desired fastener) and, upon selection of the desired fastener, the electronic control may provide the necessary commands to adjust the fastener feeder. In such embodiments, the feeder may be equipped with the necessary electronic components, as is known in the art, such as to provide the desired functionalities: a processor, RAM, non-volatile memory in which instructions may be stored (to be executed by the processor), interface with the operator (e.g. buttons, GUI on a screen, etc.), etc.

Isolator Sensor System

As known in the prior art, feeders generally have a sensor at the isolator. The sensor may be operable to detect the presence of a fastener in the isolator and, when no fastener is present, to command the system to pick a new fastener. The isolator sensor is typically positioned with a line-of-sight below the head of the fastener at the output position of the isolator. This position may be particularly useful, and generally necessary when the fastener feeder is operated with fasteners of small sizes (e.g. the fastener's head may be sufficiently small to not always be detected by the sensor). However, this positioning of the sensor may lead to a number of issues, such as when a screwdriver, or an operator, picks up the fastener from the isolator but remains in a position in which the sensor may not detect the fastener. This may result in a command for the fastener feeder to operate the isolator to pick a new fastener up; thereafter potentially causing detrimental interference with the screwdriver or the fastener gripping attachment proposed herein or operator that remained in the isolator's pathing.

As shown in the embodiment of FIGS. 8 and 9, using an additional sensor 53, which may be positioned upwards with a line-of-sight descending over the fastener 49 to be picked up, as well as the typically aligned sensor 55, may be beneficial to reduce the risks of interference to a minimum.

In the present embodiment, sensors 53, 55 may be a photoelectric sensor in which a transmitter 51 is used in conjunction with two receivers 53, 55 to provide a blocked/unblocked information to the system. As a matter of fact, a blocked line of sight between the transmitter 51 and at least one of the receivers 53, 55 may indicate the presence of a fastener 49. A person skilled in the art will appreciate that any type of sensors may be used, for example an image sensor, without departing from the teachings of this disclosure.

The sensor system may further include the controller and all of its required electronic components. As such, sensors 53, 55 may provide information to a controller having a processor, memory (volatile and non-volatile), I/O interface, etc. There may be instructions stored in memory such that, when executed by the controller's processor, the system is operable to provide a movement output based on the input from the sensors 53, 55 readings.

Process for Adjusting the Fastener Feeder

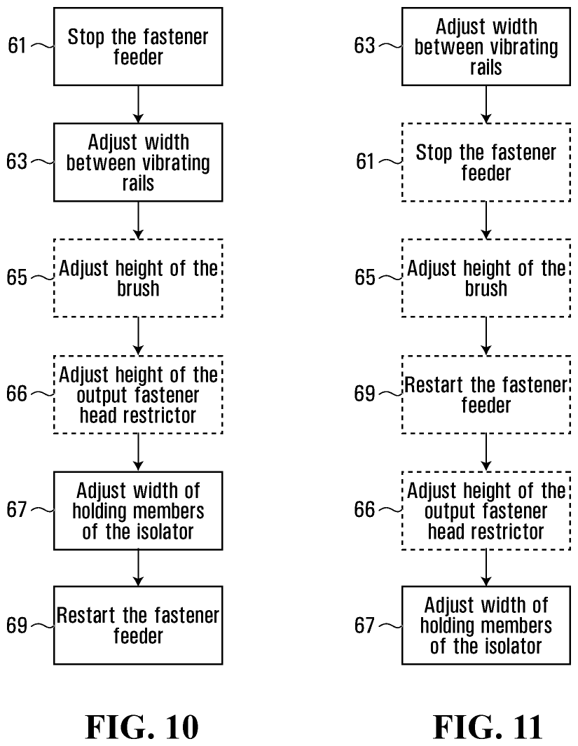

Now referring to FIG. 10 which is an exemplary method of adjusting an adjustable automatic fastener feeder according to an embodiment as described herein. In this process, the first step may be to stop the operations of the fastener feeder 61. As will be detailed in the embodiment of FIG. 11, this may be an optional step as the feeder may be adjusted while in operation. As a matter of fact, it may be beneficial to adjust the width of the gap from both the vibrating rails and the isolator while the device is operating, as it may be easier to assess whether the width of the gap is too wide (i.e. fasteners falling) or whether the width of the gap is too narrow (i.e. fasteners jamming and not moving towards the output).

The width of the gap of the vibrating rails may thereafter be adjusted 63 to accommodate the desired type and/or size of fasteners. When the size or height of a fastener is significantly different from the ones in the earlier configuration, the height of the brush may require to be adjusted 65. If required to adjust the height of the brush, the step of stopping the fastener feeder 61 may be necessary. Similarly, the height of the output fastener head restrictor may be adjusted 66 when required. As for the height of the brush, it may not always be necessary to adjust the height of the output fastener head restrictor as this part may remain effective even if a slightly greater height difference exists between the heads of the changed fasteners.

The step of adjusting the fastener holding parts of the isolator 67 may thereafter be performed. A person skilled in the art will appreciate that the adjusting steps 63, 65, 67 may be done in any order. If the feeder was stopped at step 61, the feeder may be restarted once the adjustment of the parts has been made, at step 69.

Similarly, FIG. 11 illustrates an embodiment of a method of adjusting an adjustable automatic fastener feeder in which the stopping of the fastener feeder may be limited to the adjustment of the height brush. Furthermore, as the adjustment of the height of the brush 65 may not always be required, the remaining adjustments may all be performed without stopping the operations of the fastener feeder. This may be done, as described herein, as the adjustment mechanisms are provided on the outside of the housing of the fastener feeder, resulting in no risk to an operator making the adjustments while the feeder is functioning. As previously mentioned, the adjusting of the gap of the vibrating rails 63 and the adjusting of the gap between the holding members of the isolator 67 may thus be done without stopping the feeder.

Additionally, it may be desirable to adjust the height of the brush 65. In order to do so, the feeder must be stopped 61 (i.e. as the adjustment mechanism is inside the feeder) and may be restarted at step 69 once the adjustment to the height of the brush 65 has been completed. A person skilled in the art will appreciate that the stopping and starting of the feeder may be done by an automatic control, such as an automatic stop when the clear top access window (see e.g., FIGS. 2A and 2B) is removed to access the internal parts of the feeder. This automatic stop may generally be a safety and security requirement to protect the operator. Once the feeder is stopped 61, such as by opening the clear top access window, the restarting of the feeder 69 may be required to be done by activating the power button, with the clear top access window closed. Similarly to the embodiment of FIG. 10, the height of the output fastener head restrictor may also be adjusted 66 if necessary.

Prior Art for the Fastener Gripping Attachment

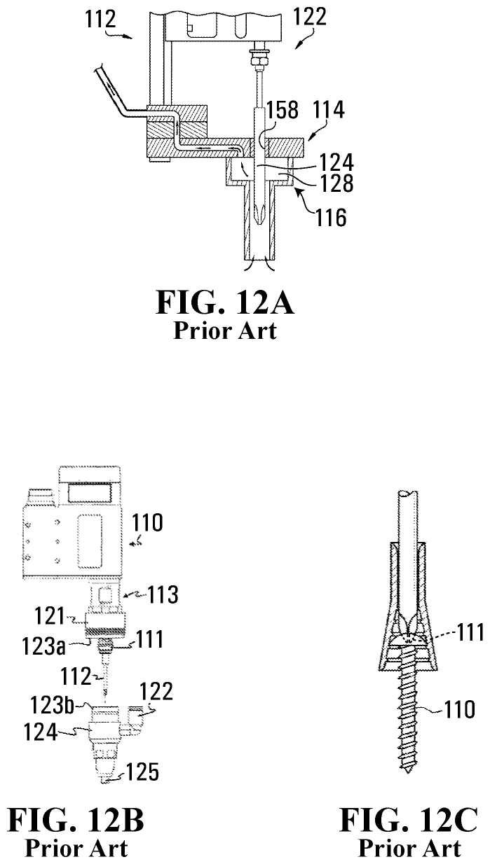

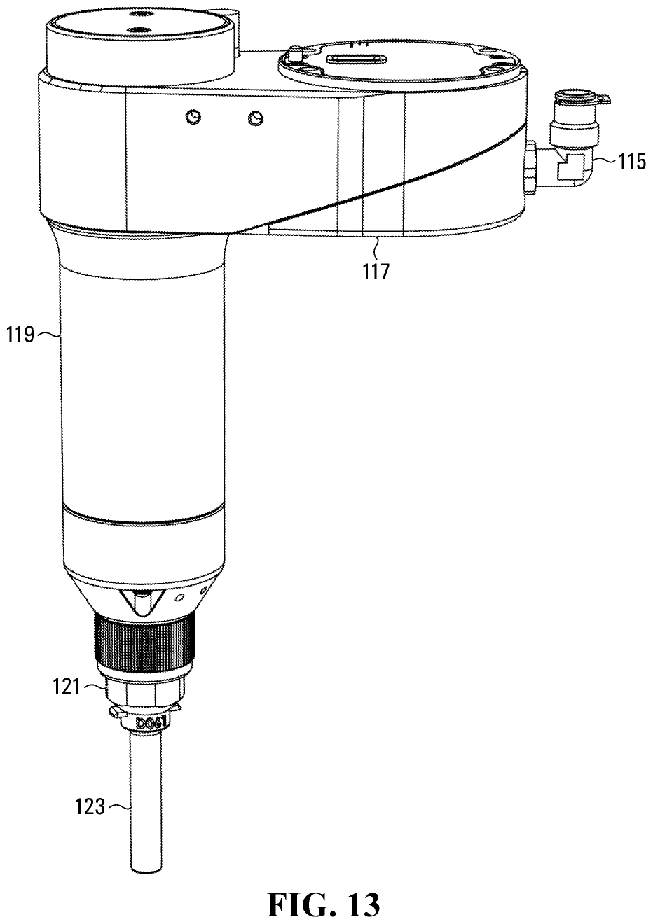

FIG. 12A illustrates one such fastener gripping mechanism using a vacuum adapter separate from the screwdriving unit. The fastener gripping mechanism may be connected to an external vacuum source through a conduit operably connecting the source to the end cavity. In this prior art configuration, the fastener gripping mechanism may attach to the screwdriving unit support frame in a position allowing the insertion and retraction of the screwdriver's bit from the vacuum end cavity. The screwdriver's bit may be changed when it is retracted from the adapter's vacuum end cavity and the adapter may further be changed to a different one in order to be used with a different fastener type or size.

A second type of prior art fastener vacuum gripping mechanism is illustrated in FIG. 12B In this configuration, the vacuum gripping mechanism is a connector mountable to the screwdriving unit itself. As such, the vacuum connector may be fixed on the screwdriver's housing and therefore covers the screwdriver's spindle and bit. The vacuum connector further includes an input connection to connect to a vacuum source.

FIG. 12C illustrates a prior art flexible screw gripping sleeve attachable to a screwdriver's bit. This sleeve is a standalone component providing a static means of securing a fastener's head to a screwdriver. In this particular design, the sleeve may be operable to be used with a number of different fastener types and sizes, depending on the degree to which it is pushed on the screwdriver's bit. For example, pushing the sleeve farther along the screwdriver's bit would necessarily entail restricting the fasteners having a larger head. As a matter of fact, the screwdriver's bit would otherwise connect with a smaller fastener head before the sides of the sleeve would engage the fastener.

Screwdriver Integrated Vacuum System

Applicant has found that the configurations of the screwdriving units described in the prior art may be significantly improved by using an integrated vacuum system. As a matter of fact, integrating the vacuum system to the casing of the screwdriving unit allows the assembly to have fewer parts, therefore providing easier operations and lowering the risks of part failures due to assembly errors. For example, numerous prior art designs include a vacuum connector to be fixed to the screwdriving unit. When removing and reassembling the vacuum connector to the screwdriver, such as when the screwdriving operations require a change of the screwdriver's bit, the connector may be misconnected or may be of the incorrect size relative to the screwdriver's bit.

The vacuum connectors being fixed over the screwdriver's bit further requires a connection to a vacuum source at an input included directly on the connector. This effectively entails that a tube, that can be a flexible tube, providing the conduit between the vacuum source and the vacuum connector, remains in the vicinity of the vacuum connector, and thus of the screwdriver's operative end (i.e. the fastener being driven), at all times. This configuration may be unsuitable for operations in certain environments, as it may be desirable to have the screwdriver operate between parts of an assembly or in places where clearance may be an issue. Being in such a position, the risk of damaging the flexible vacuum tube may further be increased. Any such damage may reduce significantly the useability of the screwdriving unit until serviced, as the vacuum may be affected to a level preventing the securing of fasteners in the vacuum connector.

Integrating the vacuum system, thus the vacuum source and the vacuum communication channels directly inside the casing of the screwdriving unit may significantly reduce the risks identified herein. As will be further described herein, the only input required to operate the vacuum may remain near the area in which the screwdriving unit is fixed to the robotic arm. The automatic screwdriver described herein may thus be used as part of the tool belt of an automated manufacturing arm, such that it may automatically provide screwing functions to an automated assembly line. As such, the flexible tube providing compressed gas may remain in a location with minimal damage risk.

FIG. 13 is a side view of an exemplary screwdriving unit including an integrated vacuum system and a vacuum gripping attachment, that can be flexible. In this embodiment, the screwdriving unit is operable to be fixed to a robotic arm, at a mounting section 117 of the unit's frame. As described herein, an input 115, for example a compressed gas input, may be provided close to the mounting section 117, such that a flexible tube connection to the input 115 may be attached to the robotic arm's structure. This configuration may allow the flexible tube to remain in a significantly safer location at all times during the screwdriving operations.

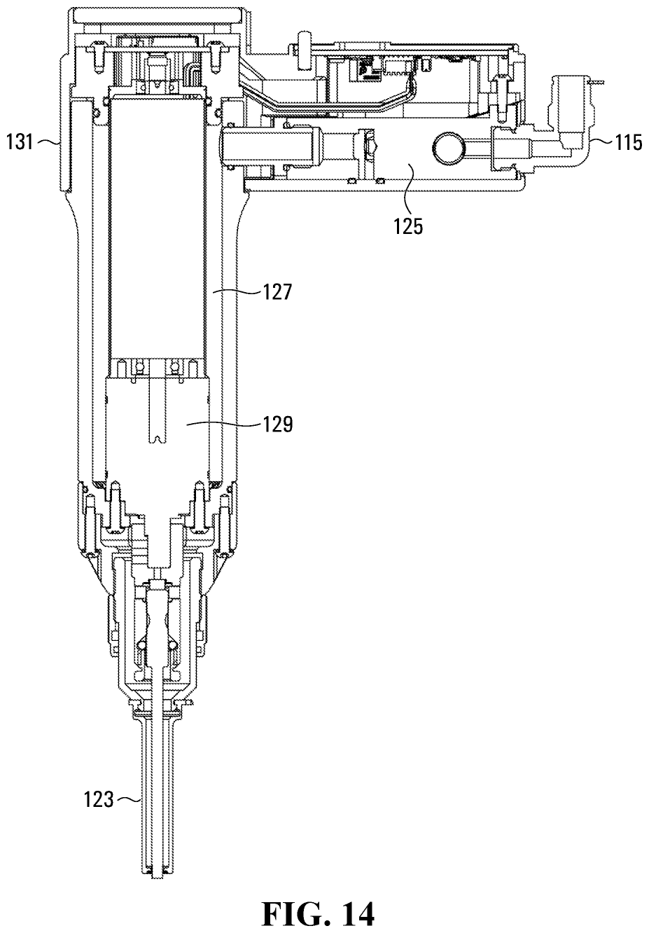

As will be further described in FIG. 14, the mounting section 117 of the screwdriving unit's housing may further include the vacuum source. The screwdriving unit's housing may further include a screwdriver motor section 19 and a screwdriver bit adapter 121. The screwdriver bit adapter 121 may be operable to secure different sizes of bits and to provide a vertical offset to the bit. The screwdriving unit may further include a sleeve 123 that may be operable to function as a fastener gripping attachment. As will be further detailed herein, the sleeve 123 may partly or fully be made of flexible, resilient or elastomeric rubber like material, for example NBR (nitrile butadiene rubber), silicone, or any other material providing a similar strength, resilience and flexibility. The flexibility of the sleeve 123 may allow its deformation when subjected to vacuum and a fastener being inserted into its opening.

In this embodiment, a flexible sleeve 123 may be fixed on the screwdriver bit adapter 121, such that it is decoupled from the screwdriver's bit itself and may therefore not be rotated during a screwdriving operation. This configuration allows the reduction in wear and tear of the flexible sleeve 123. Furthermore, as the forces acting on the sleeve are limited to the vacuum, the flexible sleeve 123 may be simply mounted to the screwdriver bit adapter 121. As a matter of fact, the top section of the flexible sleeve 123 may be simply inserted in a groove by extending the top section over the groove. The inherent elasticity of the sleeve may therefore provide an easy and fast assembling method. This further allows for quick changes to either the screwdriver's bit, the sleeve or both.

Additionally, as will be further described herein, the flexibility of the sleeve 123 renders the screwdriving operations safer. The non-rotary, flexible surface may contact parts or a person's hands or limbs without inducing as much damage as would a rotating part or a non-flexible part. Moreover, the flexible sleeve 123, as it contacts the part being fastened (i.e. as the screwdriver's bit resides inside the sleeve) may serve as a trigger to stop the screwdriving. When contacting the part being fastened, the sleeve may not damage it as may a non-flexible sleeve.

FIG. 14 is a sectional view of the screwdriving unit of the FIG. 13 embodiment, illustrating its internal components. In this embodiment, an input 15 may be operable to be connected to a source of compressed gas (e.g. compressed air). The input 115 is thereafter internally connected to a venturi vacuum system 125 to provide the vacuum to the screwdriving unit, such that fasteners may be picked up at the flexible sleeve 123. The venturi vacuum system 125, as known in the art, may therefore be in fluid communication with a vacuum enclosure 127 and a gas exhaust 131. The vacuum enclosure 127 may be included in the screwdriver's casing such that it surrounds the screwdriver's motor 129 and the screwdriver's bit. As such, the vacuum enclosure 127 may provide cooling to the motor 129 during the screwdriving operation. Additionally, this configuration may provide the advantage, over the prior art solutions, that existing screwdriving units may be upgraded with this vacuum gripping attachment by changing the screwdriver's casing. Ultimately, the vacuum enclosure 127 communicates the vacuum to the flexible sleeve 123, such that it may be used for gripping and positioning fasteners.

A person skilled in the art will understand that the vacuum system, using compressed gas and a venturi, may be replaced by any other vacuum system without departing from the teachings of this disclosure. For example, the screwdriving unit may be equipped with any other type of vacuum pump.

A person skilled in the art will further appreciate that the gas exhaust 131 may be a simple exhaust without any control mechanisms or may be a controllable exhaust. A controllable exhaust may include a valve operated by an actuator to open or close the exhaust. In such embodiments, the controllable exhaust may allow the vacuum system to operate with a positive pressure instead of a vacuum. As such, the vacuum system may be used to push gas out of the flexible sleeve 123 instead of creating a suction force. This may be particularly desirable for dislodging fasteners which may have become stuck inside the flexible sleeve 123.

Flexible Fastener Gripping Attachment

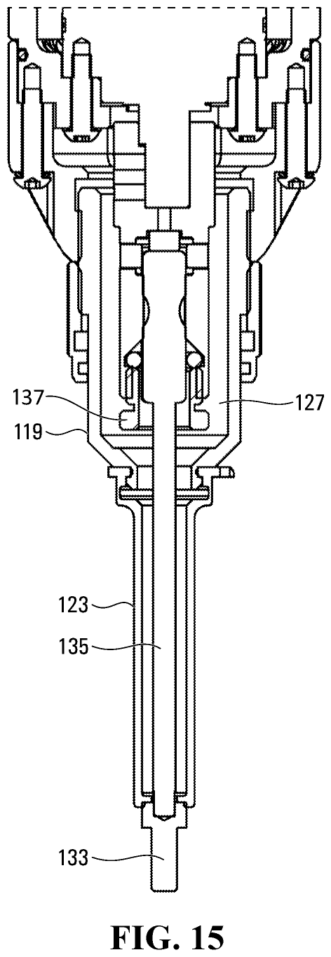

FIG. 15 is a sectional view of the spindle and flexible vacuum gripping attachment of the screwdriving unit embodiment described in FIGS. 13 and 14. The screwdriver's bit 135 may be fixed to the screwdriver's spindle such that it may be rotated by the motor during a screwdriving operation. The vacuum enclosure 127 may surround the screwdriver's bit 135 and spindle and be in fluid communication with the flexible sleeve 123. The vacuum being communicated through the flexible sleeve 123 may be sufficient to force a fastener 133 head to move inside the flexible sleeve 123 and to thereafter contact with the screwdriver's bit 135. The vacuum may be communicated around the screwdriver bit, as the flexible sleeve 123 may be hollowed throughout its length.

To fix the screwdriver's bit 135 to the spindle, the bit 135 may be inserted in a cavity which may provide tightening of the bit 135. For example, as is known in the art, the screwdriver bit adapter may be rotated to tighten or loosen the screwdriver bit 135 to the spindle, such that the bit 135 may be operated or changed to one of a different size.

In the embodiment of FIG. 15, the screwdriver's bit tightening mechanism may further include a mechanical gasket 137 providing improved alignment tolerances of the bit 135. As a matter of fact, the alignment of the screwdriver's bit 135 may have a significant impact on the efficiency of the screwdriving procedure; a misalignment of the bit 135 leading to an imbalanced vacuum force being applied to the fastener's head which may further result in the impossibility to drive the fastener in the desired part. Using a mechanical gasket 137, which provides some flexibility, allows a certain degree of misalignment of the screwdriver's bit 135 to be offset.

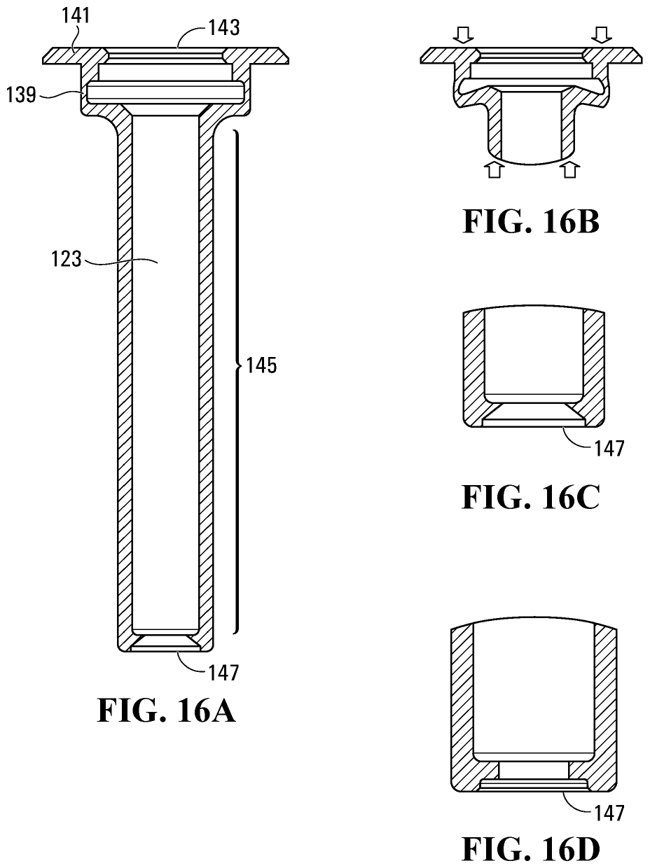

FIG. 16A is a schematic drawing of an exemplary flexible vacuum gripping attachment. In this embodiment, the flexible sleeve 123 may have a tapered fastener head guiding zone 147, as further illustrated in FIG. 16C.

In this embodiment the entire sleeve 123 is made of flexible material (e.g. NBR), the screw head guiding zones 147 may allow the alignment of a number of different types/sizes of screws or other fasteners. To cover the majority of the screwdriver's bits and screw types/sizes, a total of 118 flexible vacuum gripping sleeve 123 may be necessary. In comparison, metallic gripping sleeves, as found in the prior art, are often designed to work with a single bit and type/size of screw, requiring a high number of different sleeves to manufacture a product having different screws. This may lead to significant inefficiencies in the manufacturing process as the sleeve may need to be changed throughout the process.

The flexible sleeve 123 may include a tab 141 to ease the detachment of the flexible sleeve 123 from the screwdriver. The tab 141 may thus be of sufficient width to allow an operator to pull on it. The flexible sleeve 123 may further include a clip section 143 which may include a fast-installation clip operable to mate with a section of the screwdriver's bit adapter. A person skilled in the art will appreciate that the clip section 143 may mate on various structures of the screwdriver and may further be any type of clip allowing the flexible sleeve 123 to attach to the screwdriver. Additionally, the clip section 143 may be other types of connection securing the flexible sleeve 123 to the screwdriver.

The flexible sleeve 123 may further include a deformable section 139, which may be a section with thinner sidewalls, such as to allow vertical movement of the sleeve 123 and therefore provide some degree of compensation for misalignment of a fastener.

A person skilled in the art will appreciate that the deformable section 139 may be equivalently defined as a displaceable section. For example, a displaceable section may include a bellow or an accordion section allowing a vertical displacement of the flexible sleeve 123, similar to the functionality of the deformable section 139.

This deformable section 139 may further allow the detection of the contact between the flexible sleeve 123 and the part being fastened. For example, upon contact and downwards pressure on a part, the deformable section 139 may flex, allowing for the middle section 145 of the sleeve 123 to be deflected upwards as shown on FIG. 16B.

FIG. 16D is a schematic drawing of a washer-type fastener head guiding zone 147 of an exemplary flexible vacuum gripping attachment. In this embodiment, the washer part of the fastener may be blocked by the distal part of the fastener head guiding zone while the top section of the fastener's head may be inserted farther inside the fastener head guiding zone. This may ensure a decrease of the potential fastener misorientation and increase the stability of the fastener inside the flexible sleeve (e.g. increased surface contact between the fastener and the fastener head guiding zone).

A person skilled in the art will appreciate that any fastener head guiding zone 147 may be used at the tip of the flexible sleeve 123 without departing from the teachings of this disclosure. FIGS. 5C and 5D simply being examples of different shapes for different types of fasteners Similar shapes with different sizes may be necessary to ensure efficient vacuum gripping of the fasteners. For example, the fastener head guiding zone may be designed to accommodate any size of socket head screws, machine screws, round head screws, flat head screws, auto thread screws, etc. It will further be understood that different sizes of the flexible sleeve may be used, whether it be in its length or diameter, such that it may be used with various screwdriver bit and retain a sufficient channel width around the bit for the communication of the vacuum.

A person skilled in the art will appreciate that the sleeve may be made of more rigid material, for example metals, plastics or any other material providing a similar strength. Though one embodiment presents a one-piece elastomeric flexible molded sleeve, other embodiments of the sleeve can be made of several interchangeable sections with a combination of different materials. For example, in one embodiment a metallic middle tubular section 145 of the sleeve may be fitted in between a flexible upper section of the sleeve (the clip section 143, the deformable section 139 or the tab 141) and a plastic fastener head guiding zone 147.

Screwdriving Operations Process

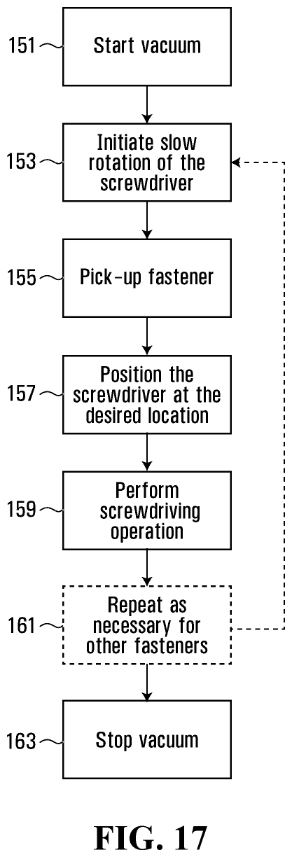

Now referring to FIG. 17 which is an exemplary method of screwdriving operations using a vacuum gripping attachment. As described herein, the screwdriving operations may have an initial step of starting the vacuum generation of the screwdriving unit 151. For example, this may be done by supplying compressed gas to an input of a screwdriving unit equipped with a venturi vacuum system. A second step may be to start a slow rotation of the screwdriver's bit 153, before picking up the desired fastener 155. The slow rotation of the screwdriver's bit, at step 153, may facilitate the insertion of the fastener's head in the screwdriver's bit. Once the fastener is secured to the screwdriver, the screwdriver may be moved to a desired location 157, such as above the hole in which the fastener is to be fastened.

Step 155, in which the screwdriver unit picks up the fastener, may include a number of different operations. For example, as the sleeve is made of resilient flexible material, the fastener's head in the vicinity may be first subjected to the vacuum and thereafter block the opening of the sleeve (i.e. the flexibility of the sleeve may allow the fastener's head to operatively block the opening). As the vacuum force is exerted on the fastener's head, the head may be further pushed inside the sleeve until it connects with the screwdriver's bit. The slow rotation of the screwdriver's bit, initiated at earlier step 153, may thereafter help the fastener's head to operatively connect with the bit. The flexible material of the sleeve may be significantly advantageous in such operation, compared to a metallic sleeve, as the fastener's head may be relatively fixed inside the sleeve until it connects with the head (e.g. there may be enough friction between the flexible material and the fastener's head to prevent the fastener from rotating until it is being driven by the slow rotation of the screwdriver). Once the fastener's head is being driven by the screwdriver, the sleeve does not prevent its rotation.

Once correctly positioned, the screwdriving operations may be performed 159. As such, the fastener may be driven inside the part to be fastened. The screwdriving operations 159 may include multiple internal steps, such as controlling the speed and torque being delivered to the fastener. The screwdriving operations 159 may then be stopped once the fastener is fully inserted, which may be controlled by various means (e.g. maximum torque threshold is reached, deflection of the flexible sleeve, etc.). As such, the screwdriver's bit may be removed from the fastener's head and thereafter the screwdriving unit may be moved to a different location (e.g. to pick up a second fastener).

The previous steps, starting at the initiation of a slow rotating speed of the screwdriver's bit 153, may be then repeated as necessary for any number of fasteners 161. Once all fasteners have been inserted at their desired location, the overall screwdriving process may be completed and the vacuum stopped 163 (e.g. by shutting off the compressed gas source to the screwdriver's vacuum system).

A person skilled in the art will appreciate that some of the above-described steps may be done in a different order without departing from the teachings of this disclosure. For example, the order of steps 151 and 153 could be reversed without affecting the method of screwdriving described.

In some embodiments, the vacuum may be stopped 163 between the operations with each fastener. For example, once the screwdriving operation is performed 159 and completed, the vacuum may be stopped 163 and the screwdriving unit may be moved to pick up a new fastener. The vacuum may then be restarted before the screwdriving unit picks up the fastener 155. Stopping the vacuum between each screwdriving operation may result in a more efficient process in which the energy used is limited.

What is claimed is:

1. A flexible vacuum fastener gripping attachment for a screwdriver comprising:
a clip section operable to secure a first end of said flexible vacuum fastener gripping attachment to a non-rotatable part of said screwdriver;
a deformable section such that an upward force exerted on said flexible vacuum fastener gripping attachment deforms said deformable section first;
a second end having a fastener head guiding zone;
a channel connecting said first end to said second end,
wherein first end of said flexible vacuum fastener gripping attachment is made of flexible material and is operable to surround a bit of said screwdriver while a vacuum is communicated in said channel.

2. The flexible vacuum fastener gripping attachment of claim 1, wherein said clip section comprises a fast-attachment clip.

3. The flexible vacuum fastener gripping attachment of claim 1, wherein said deformable section comprises a section with thinner sidewalls.

4. The flexible vacuum fastener gripping attachment of claim 1, wherein said deformable section comprises one of a bellow and an accordion section.

5. The flexible vacuum fastener gripping attachment of claim 1, wherein said fastener guiding zone is shaped to reciprocate a type of standard fastener head.

6. The flexible vacuum fastener gripping attachment of claim 1, made of a single elastomeric molded piece.

7. A screwdriving unit comprising:
a housing comprising:
a vacuum source;
a motor;
a spindle operable to receive a screwdriver bit; and
a vacuum communication channel operably connected to said vacuum source and
bordering said motor and said spindle; and
a flexible vacuum fastener gripping attachment for a screwdriver comprising:
a clip section operable to secure a first end of said flexible vacuum fastener gripping attachment to a non-rotatable part of said screwdriver;
a deformable section such that an upward force exerted on said flexible vacuum fastener gripping attachment deforms said deformable section first;
a second end having a fastener head guiding zone;
a channel connecting said first end to said second end,
wherein first end of said flexible vacuum fastener gripping attachment is made of flexible material and is operable to surround a bit of said screwdriver while a vacuum is communicated in said channel,
wherein said flexible vacuum fastener gripping attachment is attached to said housing and said vacuum communication channel is operably connected to said first end of said flexible vacuum fastener gripping attachment.

8. The screwdriving unit of claim 7, wherein said casing further comprises a compressed gas intake and a gas exhaust, and said vacuum source is a venturi vacuum device operably connected to said compressed gas intake and said gas exhaust.

9. The screwdriving unit of claim 7, wherein said clip section comprises a fast-attachment clip.

10. The screwdriving unit of claim 7, wherein said deformable section comprises a section with thinner sidewalls.

11. The screwdriving unit of claim 7, wherein said deformable section comprises one of a bellow and an accordion section.

12. The screwdriving unit of claim 7, wherein said fastener guiding zone is shaped to reciprocate a type of standard fastener head.

13. The screwdriving unit of claim 7, made of a single elastomeric molded piece.

14. A method of performing a screwdriving operation comprising:
providing a vacuum to a vacuum fastener gripping attachment;
initiating a slow rotation of a screwdriver's bit;
applying said vacuum to a fastener's head, such that said fastener's head is inserted in said vacuum fastener gripping attachment;
positioning said screwdriving unit over a desired screwdriving location;
performing said screwdriving operation;
removing said screwdriver's bit from said fastener's head; and
stopping said vacuum.
